(19) United States
(12) Patent Application Publication
(10) Pub. No.: US 2026/0127625 A1
(43) Pub. Date: May 7, 2026

(54) EQUIPMENT SERVICE, SALES, AND CONSUMER ANALYTICS PORTAL

(71) Applicant: PepsiCo, Inc., Purchase, NY (US)

(72) Inventors: Cheuk Chi LAU, White Plains, NY (US); Xuejun LI, Pleasantville, NY (US); Jacob LIETZ, Chester, NJ (US); Caroline ECO, White Plains, NY (US)

(73) Assignee: PepsiCo, Inc., Purcase, NY (US)

(21) Appl. No.: 18/935,804

(22) Filed: Nov. 4, 2024

(51) Int. Cl. G06Q 30/0202; G06Q 10/087; G06Q 30/0242

(52) U.S. Cl. CPC G06Q 30/0202; G06Q 10/087; G06Q 30/0244; G06Q 30/0246

(57) ABSTRACT

Disclosed herein are system, method, and computer program product embodiments for an equipment service, sales, and consumer analytics portal, comprising: receiving data via a network, where the data includes sensor data from a beverage system located at an edge of the network, consumable product data from the beverage system, inventory system data, and internet data; generating, by a machine learning model, a prediction using the received data including one of a repair or preventative maintenance action for the beverage system, or an action regarding the consumable product; generating, by the machine learning model a sequence of one or more actions based on the generated prediction and the received data; and initiating the sequence of one or more actions by performing at least one of sending a message to a client device associated with the beverage system or sending a command to the beverage system.

### BACKGROUND

In a food service environment, machines may be used for a variety of tasks such as food preparation, food storage, beverage storage, and sales.

These machines often include numerous parts that may fail as a result of manufacturing defects, user error, or environmental exposure. Repairing the machines is often a costly and laborious task for a variety of reasons. First, a failure needs to be identified. This often does not occur until a third party is able to physically inspect the machine. Second, the repair may be delayed because the third part may not have the means to fix the error upon arriving for an inspection. In addition to errors, machines often require preventative maintenance to extend their lifetimes. Similar to error detection, preventative maintenance also requires third party inspection. Thus, there is a need to detect and diagnose errors or likely errors in foods machines.

Additionally, these machines often include a wide range of consumable products such as different types of food and beverages. In addition to tracking the inventory levels of the consumable product, there is a need to track demand for the consumable products. Demand for certain products may vary by location and time. For example, one municipality may have a higher demand for a first product whereas a neighboring municipality may have a higher demand for a second product. Demand may vary at a more granular level. For example, a beverage system may sell more products at one corner of an intersection as compared to a different corner. Furthermore, certain products may be sold at higher rates based on their location (e.g., at eye level) within a beverage machine.

Demand may also vary by time. For example, demand for caffeinated beverages may peak between 7 am-10 am. Demand may also fluctuate based on regional events such as professional sporting events or concerts. For example, there may be high demand for a basketball player's favorite snack or drink when that player's team travels to a city for a game. Given the wide variety of circumstances that impact demand for consumable products, there is a need to not only recognize, but also predict when those circumstances are likely to occur to ensure those products are properly stocked at the relevant machines.

As discussed above, these systems may include numerous components, consumable products, and in addition, interface with hundreds or thousands of users each day. Each component, product, and interaction may include data points useful for analyzing the system and products therein. Given the concerns above, there is a need to: (1) collect real time data from a network edge; (2) perform predictive analysis on the real-time data; and (3) execute actions in response to the predictive analysis.

### BRIEF SUMMARY

Disclosed herein are system, apparatus, device, method and/or computer program product embodiments, and/or combinations and sub-combinations thereof, for an equipment service, sales and consumer analytics portal. Some embodiments relate to a method receiving, at a computing device, data via a network, where the data includes at least one of sensor data from a beverage system located at an edge of the network, consumable product data from the beverage system located at the edge of the network, inventory system data, and internet data. The method further includes generating, by a machine learning model at the computing device, a prediction using the received data. The prediction may include a repair action for a component at the beverage system, a preventative maintenance action for the component at the beverage system, or an action regarding the consumable product. Additionally, the method includes generating, by the machine learning model at the computing device, a sequence of one or more actions based on the generated prediction and the received data. The method further includes initiating, by the computing device, the sequence of one or more actions by performing at least one of sending a message to a client device associated with the beverage system or sending a command to the beverage system.

Some embodiments relate to a system with a memory and at least one processor coupled to the memory. The at least one processor is configured to receive data via a network, where the data includes at least one of sensor data from a beverage system located at an edge of the network, consumable product data from the beverage system located at the edge of the network, inventory system data, and internet data. The at least one processor is further configured to generate, by a machine learning model, a prediction using the received data. The prediction may include a repair action for a component at the beverage system, a preventative maintenance action for the component at the beverage system, or an action regarding the consumable product. Additionally, at least one processor is further configured to generate, by the machine learning model, a sequence of one or more actions based on the generated prediction and the received data. The at least one processor is further configured to initiate the sequence of one or more actions by performing at least one of sending a message to a client device associated with the beverage system or sending a command to the beverage system.

Some embodiments relate to a non-transitory computer-readable device having instructions stored thereon. When the instructions are executed by at least one computing device, the instructions cause the at least one computing device to perform operations that include receiving, at a computing device, data via a network, where the data includes at least one of sensor data from a beverage system located at an edge of the network, consumable product data from the beverage system located at the edge of the network, inventory system data, and internet data. The operations further include generating, by a machine learning model at the computing device, a prediction using the received data. The prediction may include a repair action for a component at the beverage system, a preventative maintenance action for the component at the beverage system, or an action regarding the consumable product. Additionally, the operations includes generating, by the machine learning model at the computing device, a sequence of one or more actions based on the generated prediction and the received data. The operations further include initiating, by the computing device, the sequence of one or more actions by performing at least one of sending a message to a client device associated with the beverage system or sending a command to the beverage system.

### BRIEF DESCRIPTION OF THE DRAWINGS

The accompanying drawings are incorporated herein and form a part of the specification.

FIG. 1 depicts an exemplary beverage equipment environment for an equipment service, sales and consumer analytics portal, according to some embodiments.

FIG. 2 depicts a block diagram of a machine learning module, according to some embodiments.

FIG. 3 depicts an exemplary beverage equipment planogram, according to some embodiments.

FIGS. 4A-4F depict exemplary interfaces for a service, sales, and consumer analytics portal, according to some embodiments, according to some embodiments.

FIG. 5 depicts a flowchart illustrating a method for using sensor data to take an action, according to some embodiments.

FIG. 6 depicts a block diagram of data inputs to a cloud server, according to some embodiments.

FIG. 7 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for an equipment service, sales and consumer analytics portal. The portal may be located at a cloud server in connection with one or more beverage systems via a network. The one or more beverage systems may be located at the edge of the network. The cloud server may include a machine learning model configured to analyze sensor data. For example, a beverage system may include one or more sensors configured to collect data regarding components (e.g., parts) of the beverage system, products dispensed by the beverage system, and the beverage system's surroundings. The beverage system may send, via a communications network, the collected sensor readings to the cloud server. The machine learning model at the cloud server may receive the sensor readings, analyze it, and generate various predictions based off of the sensor readings.

First, the cloud server machine learning model may be configured to predict a state of the beverage system based off of sensor data. Stated differently, the model may determine whether the beverage system has encountered or will encounter (i.e., predictively) certain conditions in one more components of the beverage system. For example, the model may detect that the beverage system is in an error state (e.g., a component is in need of repair) or requires preventative maintenance (e.g., a component may malfunction soon). In some embodiments, the condition may indicate that one or more of the components are operating normally (e.g., as expected). The model of the present disclosure may operate and determine error states without relying on defined conditions. For example, the model may rely on information from a combination of sensors of the beverage system to dynamically detect operating conditions of beverage system components, and determine that one or more of the components is an error state based on the combined information. That is, as opposed to detecting that a component is operating outside of a predefined acceptable temperature threshold (i.e., a static error condition), the model may determine that the component is in an error state despite operating within conventionally acceptable temperature thresholds (i.e., a dynamic error condition). This error state is based on the model processing information from multiple sensors to determine whether the operating condition of a component is acceptable. This process may also be used to predict when preventative maintenance for a component is needed. For example, the model may learn that certain sensor readings indicate a component is likely going to fail, and therefore preventative maintenance is needed. Leveraging the model in this way allows for tailored preventative maintenance to be identified. Whereas a prior art system may leverage static thresholds to identify preventative maintenance, here, the optimal thresholds for when preventative maintenance may be learned. As a result, beverage systems of the present disclosure may each have their own custom preventative maintenance schedules learned via their respective machine learning models.

The model may be further configured to generate actions for a self-healing process. The self-healing actions may be repairs generated based on the detected condition. For example, the model may detect that the temperature within the beverage system is rising beyond normal limits or predict that the temperature will rise. In response, the model may predict that an action or a series of actions, such as engaging an air conditioner, are needed to reduce the temperature. In some embodiments, the model may predict an action involving ordering new parts. Here, the model may generate an order form, execute a purchase, such as by sending the order form to a supplier, and contacting a repair entity to install the new parts at the beverage system. In some additional embodiments, the model may predictively and dynamically modify and/or optimize operating conditions so as to prolong the life of certain components and reduce the instances where maintenance and/or intervention are required.

Second, the cloud server machine learning model may be configured to generate predictions using sensor data and consumable product data. Consumable product data may include, but is not limited to: (1) product name; (2) product price; (3) product quantity/amount; (4) product stock date; (5) expected product restock date; and (6) product sales. In some embodiments, the cloud server machine learning model may be configured to generate predictions using customer data including, but not limited to, age, sex, occupation, salary, home address, and/or education. For example, the cloud server machine learning model may predict that a beverage system should be restocked with higher priced beverages because the average salary of customers purchasing items from the beverage system is higher compared to beverage systems in the surrounding area. In some embodiments, the customer data may be based off of a credit card, debit card, or other payment method used by a customer to purchase a consumable product from a beverage system.

Consumable product data may further include planogram data. Planogram data may indicate a physical layout of consumable products within the beverage system. For example, if the beverage system is a cooler, the planogram data may subdivide the beverage system into a grid, and include an indication of the product at each coordinate within the grid. The cloud server model may further include internet data such as news sources, social media, and traffic data to generate predictions

The cloud server machine learning model may generate predictions using the sensor, consumable product data, customer data, and internet data. For example, predictions may include, but are not limited to, products to restock, optimal restock times, new products to add to the beverage system, products to remove from the beverage system, an updated planogram for the beverage system, and a new location for the beverage system. In contrast to prior art systems that may solely rely on consumable product data such as sales, the model described herein may be able to leverage sensor data, consumable product data, customer data, and internet data to generate real-time predictions. For example, a prior art system may determine a time to restock a beverage system by comparing a current inventory to a predefined restock threshold. In contrast, the cloud server machine learning model described herein may learn an optimal restock time based off of current inventory, customer data, local weather patterns, the times sales occur, the times foot traffic is highest near the beverage system, the time vehicle traffic is highest near the beverage system, and an upcoming professional sporting event. Furthermore, the model may generate these predictions in real-time, allowing beverage system owners and servicers to take advantage of real-time events (e.g., a spike or drop in temperature, sporting events, and concerts).

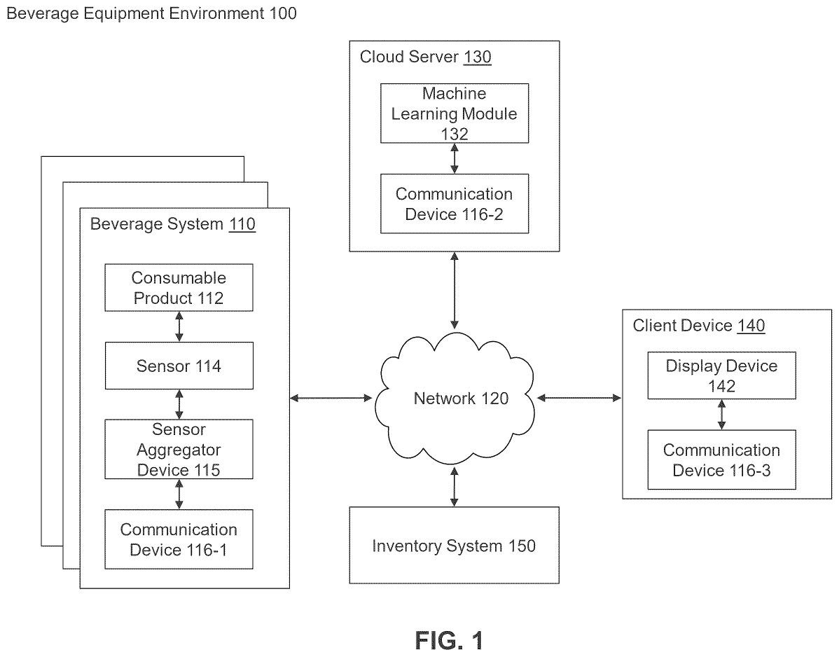

FIG. 1 depicts an exemplary beverage equipment environment 100 for an equipment service, sales and consumer analytics portal, according to some embodiments. Beverage equipment environment 100 includes beverage system 110, network 120, cloud server 130, client device 140, and inventory system 150.

Beverage system 110 may be any device capable of housing a consumable product. In some embodiments, beverage system 110 may be a cooler to store pre-packaged beverages and other items (e.g., a vending machine). In some embodiments, beverage system 110 may house and dispense beverages (e.g., a drink dispenser). Although a single beverage system 110 is depicted, beverage equipment environment 100 may include any number of beverage systems 110. Beverage system 110 includes consumable product 112, sensor 114, sensor aggregator device 115, and communication device 116-1.

Consumable product 112 may be any product capable of being stored within beverage system 110. Consumable product 112 may include packaged beverages or packaged food products. In some embodiments, consumable product 112 may include a syrup that is mixed with a fluid (e.g., carbonated water) to create a drink. In some embodiments, consumable product 112 may be dispensed in response to a user's interaction with beverage system 110. For example, consumable product 112 may be a prepackaged beverage and beverage system 110 may include an interface for a user to select a desired consumable product 112. A user may interact with the interface, such as by selecting an identifier corresponding to consumable product 112. In response, beverage system 110 may dispense the selected consumable product 112. Consumable product 112 may be arranged within beverage system 110 according to a planogram. A planogram may be used to define the location of consumable products 112 within beverage system 110. For example, beverage system 110 may be divided into a grid layout, and consumable product 112 may be assigned to a grid. In some embodiments, the same consumable product 112 may be assigned to multiple positions within the planogram. For example, consumable product 112 may be a particular type of soft drink and it may be assigned to multiple positions within beverage system 110. This may be based on current inventory levels of the soft drink, popularity, or any other reason. In some embodiments, consumable product 112 may be different at each location within beverage system 110. As stated above, a user may interact with beverage system 110, input an identifier, and receive consumable product 112. In some embodiments, the identifier input by the user may also be the value of consumable product's 112 location within the planogram. For example, A1 may be the topmost, leftmost position within beverage system 110. A user may input A1 to retrieve consumable product 112 at A1 within the planogram, within beverage system 110.

Sensor 114 may be any device capable of gathering data from an environment, such as beverage equipment environment 100. Sensor 114 may be a camera (internally and/or externally facing), thermometer, accelerometer, humidity sensor, noise sensor (e.g., a microphone), magnetometer, voltmeter, electrical current sensor, light sensor, infrared (IR) sensor, vibration sensor, GPS, flowmeter, tilt detector, loadcell, or proximity sensor, but is not limited to the sensor types listed. Sensor 114 may be an access point, cellular base station, Bluetooth receiver, RFID device, or NFC device.

Sensor 114 may be configured to gather data about the internal (e.g., components) and external environment of beverage system 110. For example, sensor 114 may gather data about beverage system's 110 internal conditions, such as temperature or voltage usage. In some embodiments, sensor 114 may gather data about the external environment where beverage system 110 is located, such as ambient temperature, humidity level, and detection of nearby objects. Sensor 114 may further gather data including levels of energy consumption at beverage system 110. For example, sensor 114 may gather energy consumption data when beverage system 110 is in different states (e.g., idling, dispensing a beverage). Sensor 114 may gather information about beverage system's 110 location. For example, sensor 114 may be a GPS configured to determine beverage system's 110 location. Sensor 114 may be configured to determine an orientation (e.g., north, south, east, and west) of beverage system 110.

Sensor 114 may be configured to track user interactions with beverage system 110. For example, sensor 114 may track consumable product 112 that is purchased or otherwise dispensed to a user. Sensor 114 may be a camera including capable of identifying a human within images and video. Here, sensor 114 may track the number of individuals that pass beverage system 110, interact with and purchase consumable product 112 from beverage system 110, interact with but don't purchase consumable product 112 from beverage system 110. Sensor 114 may be further configured to perform gaze detection in order to infer a specific consumable product 112, or class of consumable products 112 a consumer is interested in. For example, sensor 114 may use gaze detection to estimate a location of the planogram the user is looking, and in order to infer interest in consumable product 112 located at or near the user's gaze.

Sensor 114 data may be used to detect a number of users nearby beverage system 110 via wireless technologies. For example, sensor 114 may be a wireless access point. Here, sensor 114 may detect a number of unique nearby beverage system 110. Similarly, sensor 114 may be a cellular base station and detect a number of IMEIs or other cellular device identifiers near beverage system 110. Sensor 114 may be a Bluetooth receiver configured to receive Bluetooth beacons. Sensor 114 may be an RFID or NFC device configured to detect RFID or NFC signals.

Sensor aggregator device 115 may receive data from sensor 114. Sensor aggregator device 115 may format received sensor data. For example, sensor aggregator device 115 may standardize the format of sensor data. In some embodiments, this may involve manipulating output from each sensor 114 so that each output has the same dimensionality. For example, sensor aggregator device 115 may upsample, downsample, filter, and/or transform data from each sensor 114. This may be beneficial so that the data may be used together and/or compared, for example, during training of the machine learning model provided by machine learning module 132. Sensor aggregator device 115 may be configured to label the source of the sensor data. For example, sensor aggregator device 115 may label images or video from a camera (e.g., sensor 114) with a tag “camera.” This may be useful so that other components of beverage equipment environment 100 can determine the source of the data.

In addition to labeling the type of sensor 114, sensor aggregator device 115 may append a component identifier to data provided by a particular component, such as a sensor identifier to data provided by sensor 114. For example, beverage system 110 may include two camera sensors 114. Each camera sensor 114 may have a unique identifier. Sensor aggregator device 115 may append the identifier of each camera sensor 114 to the data from the respective camera sensor 114. This may be beneficial to determine which images or video came from which camera sensor 114. Sensor data output by sensor aggregator device 115 may be transmit from beverage system 110 to cloud server 130.

Beverage system 110 may be located at the edge of network 120. Beverage system 110 may continuously transmit sensor 114 data to cloud server 130. In some embodiments, beverage system 110 may periodically transmit sensor 114 data to cloud server 130. For example, beverage system 110 may collect sensor 114 data and transmit the collected data once per day, twice per day, etc. Beverage system 110 may use communication device 116-1 to send and receive communications. For example, output from sensor aggregator device 115 may be sent to communication device 116-1 for transmission to cloud server 130.

Beverage system 110 may further transmit consumable product 112 data to cloud server 130. For example, beverage system 110 may send cloud server 130 inventory data regarding consumable product 112. Beverage system 110 may also send consumable product's 112 sales data to cloud server 130. Sales data may include consumable product 112, price, time, and date. Sales data may further include planogram data such as a location of consumable product 112 within beverage system 110 when the sale was made.

Beverage system 110 may further cause cloud server 130 to obtain customer data. In some embodiments, when a customer purchases consumable product 112 at beverage system 110, beverage system 110 may obtain authorization for the transaction via cloud server 130. For example, beverage system 110 may send the customer's credit card or other payment method information to cloud server 130 and cloud server 130 may obtain authorization from a financial institution associated with the payment method. As part of the transaction, cloud server 130 may obtain customer data linked to the payment method used by the customer. For example, the financial institution may provide cloud server 130 with customer data. In some embodiments, beverage system 110 may directly communicate with the financial institution to authorize the transaction. Similarly, beverage system 110 may obtain the customer data from the financial institution and send the customer data to cloud server 130. In some embodiments, the customer may have a user account associated with beverage system 110. The customer may have provided their customer data when creating the user account and linked their payment method (e.g., credit card) to their user account. Thus, when the customer purchases consumable product 112 using the linked payment method, beverage system 110 and/or cloud server 130 may link the customer data to the purchase of consumable product 112. For example, cloud server 130 may maintain a history of the customer's purchases within the user account.

Cloud server 130 may use data received from beverage system 110 to build training data and test data sets. As will be discussed below, machine learning module 132 may improve one or more machine learning models through training and testing processes. In some embodiments, cloud server 130 may build training and testing data with data from beverage system 110. For example, machine learning module 132 may predict a new planogram for beverage system 110. Cloud server 130 may transmit the updated planogram to beverage system 110. Beverage system 110 may update the planogram (e.g., automatically, or via a third party), and send collected data to cloud server 130. For example, beverage system 110 may send sensor 114 data and data regarding consumable product 112 such as sales and interactions not resulting in sales to cloud server 130. This data may then be used to update machine learning module 132. For example, machine learning module 132 may use the data to train one or more machine learning models to learn the effect that the updated planogram had on the sales of consumable product 112.

Communication device 116-1 may be configured to communicate with cloud server 130 and client device 140 via network 120. Communication device 116-1 may comprise any suitable network interface capable of transmitting and receiving data, such as, for example a modem, an Ethernet card, a communications port, or the like. Communication device 116-1 may be able to transmit data using any wireless transmission standard such as, for example, Wi-Fi, Bluetooth, cellular, or any other suitable wireless transmission.

Network 120 may be any type of computer or telecommunications network capable of communicating data, for example, a local area network, a wide-area network (e.g., the Internet), or any combination thereof. The network may include wired and/or wireless segments.

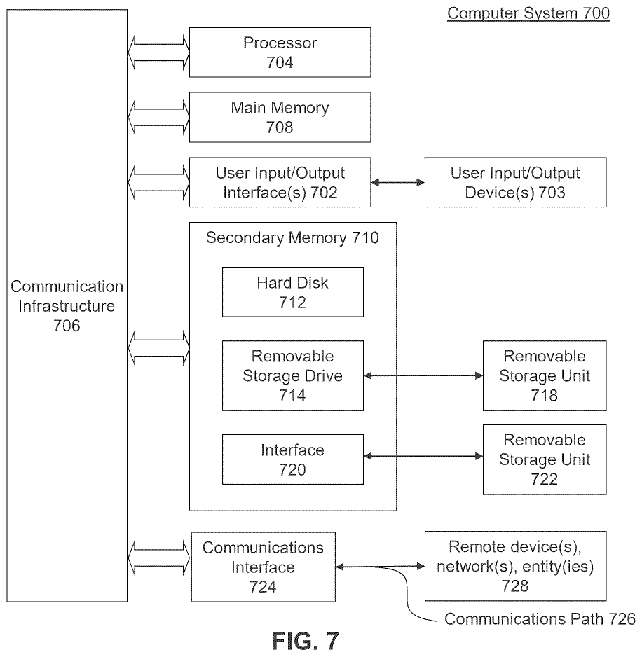

Cloud server 130 may be implemented using one or more servers and/or databases. In some embodiments, cloud server 130 may be implemented using a computing device such as a desktop workstation, laptop or notebook computer, netbook, tablet, smart phone, and/or other computing device. In some embodiments, cloud server 130 may be implemented as an application in an enterprise computing system and/or a cloud-computing system. In some embodiments, cloud server 130 may be a computer system such as computer system 700 described with reference to FIG. 7. Although a single cloud server 130 is depicted, beverage equipment environment 100 may include multiple cloud servers 130.

Cloud server 130 includes communication device 116-2 and machine learning module 132. Cloud server 130 may communicate with beverage system 110 using communication device 116-2. Cloud server 130 may leverage machine learning module 132 to analyze received data from beverage system 110 such as data from sensor 114. Cloud server 130 may combine data from beverage system 110 with other system data. For example, cloud server 130 may input data from multiple beverage systems 110 into machine learning module 132. In some embodiments, cloud server 130 may retrieve data from the internet, combine it with data from beverage system 110 and input it to machine learning module 132. For example, cloud server 130 may retrieve traffic information nearby beverage system 110, and input the traffic information and sensor 114 data from beverage system 110, into machine learning module 132.

Cloud server 130 may maintain a portal. The portal may be used to provide devices, such as client device 140, information regarding beverage system 110. Client device 140 may access the portal upon connecting to cloud server 130. The portal may be displayed on display device 142 at client device 140. The portal may display a list or map of beverage systems 110. The portal may further display beverage system's 110 connection status such as whether the listed beverage systems 110 are currently connected to cloud server 130. The beverage systems 110 may be connected to cloud server 130 via network 120. The portal may further display beverage system 110 status information such as whether it's functioning normally or has encountered an error. The portal may further display component statutes. For example, beverage system 110 may include two motors and the portal may include status for both motors. Similarly, beverage system 110 may include one or more lights and the portal may list status for each light. The status may include whether the component is on or off. The status may further include whether the component is functioning normally or in an error state. The portal may display a map of beverage system 110 locations. The portal may further display status related to components of beverage system 110. For example, the portal may include a list of sensors 114 connected to beverage system 110.

The portal may display sales data for consumable product 112 at beverage system 110. For example, the portal may display a type of consumable product 112 and an amount sold over a time period (e.g., week, month, and year). The portal may further show the days, and times that sales occur. For example, the portal may display a bar graph showing sales data per weekday. As an additional example, the portal may show a bar graph showing sales by hour of the day. The portal may also show data regarding how consumable products 112 were purchased such as consumable products 112 purchased with cash versus credit cards. Here, the portal may show the bank associated with the credit card that was used. The portal may also show the locations of where sales occur. For example, the portal may show a heat map indicating density of sales by location. The heat map may be broken down by type of consumable product 112. For example, a user may interact with the portal to display sales heat map data for a particular consumable product 112.

The portal may display information related to beverage system 110 gathered by sensor(s) 114. For example, the portal may display temperature, electricity usage (e.g., kilowatts/hour), humidity levels, noise, vibration, and magnetism data. The portal may also be configured to live stream data from beverage system 110. For example, the portal may display a live camera feed from sensor 114 at beverage system 110. The portal may further host a live audio feed from beverage system 110. The portal may further display nearby device location. As discussed above, sensor 114 may be a wireless access point, cellular base station, Bluetooth receiver, RFID device, or NFC device. Here, the portal may display a number of devices recognized by sensor 114. In some embodiments the portal may display a unique number of devices recognized.

The portal may further display information from other sources such as the internet or inventory system 150. For example, the portal may a map showing traffic data with the locations of beverage systems 110 overlaid. The portal may also display a list of events near beverage system 110 and trending social media posts made near to or mentioning areas near beverage system 110. The portal may further display weather data near beverage system 110 and news updates near beverage system 110. The portal may list locations related to inventory system 150 such as warehouse locations, distribution locations, and manufacturing plant locations. The portal may further list information from inventory system 150 such as consumable products 112 ready to ship and consumable products 112 in transit with expected delivery information.

The portal may also display current consumable products 112 at beverage system 110. The portal may display each type of consumable product 112 at beverage system 110 and their quantities. The portal may further display a current planogram at beverage system 110 showing where consumable products 112 are located within beverage system 110.

As will be discussed below, machine learning module 132 may be used to generate predictions and analysis. Here, the portal at cloud server 130 may be configured to display the predictions and analysis generated by machine learning module 132.

Cloud server 130 may leverage machine learning module 132 to generate predictions regarding beverage system 110. Predictions may relate to the state of beverage system 110, consumable product, 112, or a combination thereof. Cloud server 130 may receive data from sensor 114 at beverage system 110 and input it to machine learning module 132 for analysis. Cloud server 130 may further retrieve data from inventory system 150 and input it to machine learning module 132. Cloud server 130 may receive customer data of a consumer that purchased consumable product 112 from beverage system 110. In some embodiments, the customer data may be sent to cloud server 130 by a financial institution that authorized the purchase. Cloud server 130 may further request data the internet via network 120. For example, cloud server 130 may send a series of HTTP requests, receive HTTP responses, and forward the responses to machine learning module 132. Cloud server 130 may request any data on the internet, including, but not limited to: weather data, traffic data, public event data (e.g., festival, sporting event, and concert, and protest), social media data, mapping/navigation data, and news data. As an example, machine learning module 132 may predict that consumable product 112 at beverage system 110 needs to be restocked. Machine learning module 132 may be configured to identify an optimal route for a delivery driver to restock beverage system 110. Here, machine learning module 132 may query one or more online mapping tools to gather traffic data surrounding beverage system 110. Machine learning module 132 may take this information into account while generating the delivery route. Cloud server 130 may therefore be configured to be in communication with one or more mobile units on which one or more dedicated software programs may be installed for communicating with machine learning module 132, and receiving the optimized delivery routes.

In some embodiments, cloud server 130 may request internet data and/or inventory system 150 data each time it receives data from beverage system 110. For example, once cloud server 130 receives sensor 114 data from beverage system 110, cloud server 130 may query the internet for data local to beverage system 110 such as weather, traffic, event, and social media data. Additionally, cloud server 130 may also query inventory system 150 for available data such as estimated production times, restock times, etc. Cloud server 130 may combine data prior to inputting it to machine learning module 132. For example, cloud server 130 may transform the received data into numerical vector formats by applying one or more embedding algorithms. Cloud server 130 may combine the vectors into a single matrix, and input the matrix into machine learning module 132. In some embodiments, cloud server 130 may generate labels for the categories of data within the matrix. Cloud server 130 may prepend a label at the first index of each vector within the matrix, where the label corresponds to the data source or type. This may be beneficial so that machine learning module 132 can determine the type of data it receives. This may also be beneficial in scenarios where the data input to machine learning module 132 changes. For example, at one iteration, traffic data may be included within the matrix input to machine learning module 132. However, on a second iteration, traffic data may not be included. Thus, labeling the category of data may beneficial so that machine learning module 132 can determine the types of data available.

Machine learning module 132 may include one or more machine learning model(s) trained to analyze sensor data, such as data regarding consumable product 112, sensor 114, the internet, a customer, and/or inventory system 150. In some embodiments, machine learning module 132 may include a single model. In some embodiments, machine learning module 132 may include a model for each type of data. For example, machine learning module 132 may include a model for each sensor 114 at beverage system 110. For example, machine learning module 132 may include a first model to input and generate predictions for image and video data from camera sensor, and a second model to input and generate predictions for temperature readings generated by a thermometer. In some embodiments, machine learning module 132 may include a model per category of analysis. For example, machine learning module 132 may include a model configured to generate predictions regarding repairs and maintenance, and a model configured to generate predictions regarding products (e.g., consumable product 112).

Regarding repairs and maintenance, machine learning module 132 may receive data from sensor aggregator device 115, and use the sensor data as an input to a machine learning model. The output may be a prediction as to whether the sensor data is normal or includes an anomaly. An anomaly may indicate that beverage system 110 is currently in an error state or requires preventative maintenance. Machine learning module 132 may further predict actions such as steps to repair an error at beverage system 110 or steps to perform the preventative maintenance. For example, if machine learning module 132 determines beverage system 110 has encountered an error, it may predict reparative actions such as power cycling beverage system 110. In some embodiments, predicted actions may involve external entities such as ordering replacement components for beverage system 110. Predicted actions may further involve contacting repair entities to perform repairs or preventative maintenance on beverage system 110.

Regarding consumable product 112, machine learning module 132 may generate predictions based off of all available data sources such as data from sensor aggregator device 115, internet data, customer data, and inventory system 150 data. Machine learning module 132 may further incorporate estimated energy consumption for predicted actions. For example, machine learning module 132 may be configured to predict actions that are most environmentally friendly (e.g., utilize recycling, most fuel-efficient, lowest carbon emissions, utilize electric vehicles, or utilize hybrid vehicles).

In some embodiments, machine learning module 132 may predict that consumable product 112 needs to be restocked. In some embodiments, this may be based off of a number of consumable products 112 stored at beverage system 110. In some embodiments, the prediction may be based off of an expected demand for consumable product 112. For example, cloud server 130 may access the internet and retrieve data regarding upcoming events near beverage system 110. Events may include concerts, sporting events, conferences, political campaign activities, protests, trade shows, and local weather. Here, based off of the event data, machine learning module 132 may predict that there may be more demand for consumable product 112 than there would be without the event. As a result, machine learning module 132 may predict that consumable product 112 should be restocked even if current inventory levels are above a restock threshold. Similarly, machine learning module 132 may predict that consumable product 112 should not be restocked if the local weather data indicates a hurricane is approaching the location of beverage system 110.

Machine learning module 132 may predict actions to increase sales of consumable product 112. As noted above, consumable beverage(s) 112 within beverage system 110 may be arranged according to a planogram (e.g., a baseline planogram). Machine learning module 132 may predict a recommended planogram (e.g., an updated planogram) for beverage system 110 in order to increase consumable product's 112 sales. The recommended planogram may be based off of the baseline planogram, as well as sensor and consumable product 112 purchase data. For example, machine learning module 132 may learn a pattern indicating that consumable products 112 positioned near human eyelevel sell at higher rates than consumable products 112 above or below eyelevel. As a result, machine learning module 132 may predict a new planogram (e.g., a recommended planogram) configured such that the most profitable consumable products 112 are positioned at eye level and the least profitable consumable products 112 are at the bottom and top of the planogram. In some embodiments, cloud server 130 may send a new planogram configuration to beverage system 110 for implementation. Beverage system 110 may be configured to move consumable product 112 based off of a received planogram. For example, beverage system 110 may include collection of movable shelves to change where consumable products 112 are located within beverage system 110. In some embodiments, cloud server 130 may send the recommended planogram to a third party responsible for servicing beverage system 110. The third party may physically move consumable products 112 at beverage system 110 to implement the planogram.

For example, machine learning module 132 may include a large action model (e.g., machine learning model 200) configured to predict and execute a sequence of one or more steps to update the planogram at beverage system 110 and confirm that the update was successful. For example, the LAM (e.g., machine learning model 200) may send the third party the location of beverage system 110, a time to update the planogram, and the updated planogram. The LAM may further request proof of the update such as a photo or video. The LAM may compare the received photo or video to the recommended planogram in order to confirm that the update was successful. Similarly, the LAM may send beverage system 110 a command to updates its planogram. As stated above, beverage system 110 may be configured to update its planogram via one or more movable shelves. Here, beverage system 110 may update its planogram and send an acknowledgement message, including the updated planogram, to the LAM at cloud server 130. In some embodiments, the LAM at cloud server 130 may confirm the planogram is updated by inspecting planogram data sent from beverage system 110 to cloud server 130 as part of a heartbeat or status message.

Machine learning module 132 may predict a new location and/or orientation for beverage system 110. In some embodiments, the new location may be in order to increase the number of sales of consumable product 112 at beverage system 110. For example, machine learning module 132 may predict that locations with higher foot traffic may result in increased sales of consumable product 112. Here, machine learning module 132 may predict a new location for beverage system 110 that is predicted to have higher foot traffic. Machine learning module 132 may predict areas with higher foot traffic based off of visual data. For example, beverage system 110 may include multiple cameras (e.g., sensors 114) configured to capture images and/or video from beverage system's 110 surroundings. Machine learning module 132 may input the camera data and determine that another area (e.g., across the street) has higher foot traffic than where beverage system 110 is currently located. This determination may be made by identifying and counting the number of individuals at beverage system's 110 current location versus another area (e.g., across the street).

Machine learning module 132 may further predict areas with higher foot traffic based on signal data. For example, sensor 114 may include a wireless access point, cellular base station, and Bluetooth receiver. Here, machine learning module 132 may input measurements from sensor 114 such as the number of unique devices identified by sensor 114, and respective received signal strength indicators, to determine whether more devices are passing close to beverage system 110 or not. If devices are not passing near beverage system 110, machine learning module 132 may recommend that beverage system 110 be moved closer to where devices are passing.

Here, machine learning module 132 may sequence multiple models together to predict a new location and/or orientation for beverage system 110. For example, a first machine learning model 200-1 may be a large language model (LLM), configured to predict a new location or orientation of beverage system 110. The output of the LLM (e.g., first machine learning model 200-1) may be input to a second machine learning model 200-1. The second machine learning model 200-1 may be a large action model (LAM). The LAM may be trained to predict one or more steps to implement the prediction generated by the LLM. For example, the LAM may: (1) identify an entity capable of moving and/or reorienting beverage system 110; (2) identify a time to execute the move and/or reorientation; and (3) communicate with the entity via network 120 to execute the move and/or reorientation.

In some embodiments, the LAM (e.g., second machine learning model 200-1) may publish updates to the portal at cloud server 130. This may be beneficial so that the operation's progress may be monitored. Additionally, the LAM may publish at the portal and/or send alerts if the operation cannot be implemented. For example, the LAM may have been unable to identify an entity capable of moving and/or reorienting beverage system 110. As a result, the LAM may publish an alert to the portal at cloud server 130. This may be beneficial so that an entity accessing the portal can determine that beverage system 110 requires attention. In some embodiments, the LAM may confirm that the action was successful. For example, the LAM may receive photo or video information indicating that the operation (e.g., move, reorientation) has been completed. The LAM may compare the received information to expected information, to verify the action was successful. For example, the LAM may compare a photo of beverage system 110 in a new orientation, to the orientation it sent to the third party, to determine its instructions were followed. Similarly, if LAM told a third party to move beverage system 110 to a new location, the LAM may compare GPS or other location data from beverage system 110, to the location it sent to the third party, to confirm beverage system 110 is in the correct location. Similar to the alerts above, the LAM may publish at the portal and/or send alerts based on feedback received. For example, the LAM may publish and/or send alerts indicating whether the operation (e.g., the move or reorientation) was successful or unsuccessful.

Machine learning module 132 may assign each prediction corresponding the models' confidence associated with the prediction. Regarding repairs, for example, machine learning module 132 may generate three actions: (1) activate fan; (2) cycle power; and (3) deactivate lights, with respective confidence scores: (1) 80%; (2) 15%; and (3) 5%. Here, cloud server 130 may cause the action with the highest confidence score to be executed. Regarding products, machine learning module 132 may predict that consumable product 112 needs to be restocked. Machine learning module 132 may further predict optimal times to restock beverage system 110. Times may be determined based off of various factors such as when sales occur at beverage system 110, consumable product 112 current inventory, vehicle traffic data near beverage system 110, and upcoming events near beverage system 110. As an example, machine learning module 132 may predict three delivery times: (1) Monday at 9 am; (2) Wednesday at 6 pm; and (3) Friday at 11 pm, with respective confidence scores: (1) 10%; (2) 20%; and (3) 70%. As a further example, machine learning module 132 may predict locations for beverage system. Machine learning module 132 may assign a probability to each location, corresponding to machine learning module's 132 confidence that the respective location will increase sales of consumable product 112. Machine learning module 132 may output the action with the highest confidence score.

In some embodiments, machine learning module 132 may consider energy consumption when selecting an action. For example, machine learning module 132 may be configured to predict energy consumption levels associated with each prediction. In some embodiments, machine learning module 132 may output an action with low energy consumption (e.g., environmentally friendly). For example, machine learning module 132 may predict that consumable product 112 at beverage system 110 needs to be restocked. Machine learning module 132 may access a database to determine available distributors capable of restocking consumable product 112. Machine learning module 132 may consider the distance between each distributor and beverage system 110 when identifying which distributor to restock beverage system 110. Here, distance may be used as a proxy for energy consumption and/or emissions when making the delivery. For example, machine learning module 132 may determine the most fuel-efficient restock option by recommending routes that consume the least amount of fuel or recommending supply carriers that utilize hybrid or electric vehicles. Similarly, machine learning module 132 may predict a restock time correlated with the lowest amount of traffic near beverage system 110 to reduce emissions associated with the delivery. Similarly, machine learning module 132 may predict to restock consumable product 112 based on local regulations indicating materials that can be recycled in the locality of beverage system 110. For example, consumable product 112 may be a soda that may be in an aluminum can or a plastic bottle. The locality where beverage system 110 may only have the ability to recycle aluminum cans. As a result, machine learning module 132 may predict that the aluminum can version of consumable product 112 should be restocked at beverage system 110 so that it can be recycled.

Similarly, machine learning module 132 may incentivize environmentally friendly actions by favoring environmentally friendly distributors. For example, the database of distributors may further include an environmental score for each distributor. The score may be based off of actions such as use of clean energy, recycling efforts, and/or water usage. In some embodiments, machine learning module 132 may use the environmental score when identifying a distributor. For example, machine learning module 132 may select the distributor with the highest environmental score.

In some embodiments, machine learning module 132 may predict that consumable product 112 needs to be discarded. For example, a beverage at beverage system 110 may have expired, and therefore needs to be replaced. Here, machine learning module 132 may identify an entity capable of recycling the expired consumable product, as opposed to one that will discard it.

Predictions by machine learning module 132 may be accessible via a portal at cloud server 130. As stated above, cloud server 130 may host a portal accessible via network 120. The portal may display data from beverage systems 110, as well as analysis generated by machine learning module 132. For example, the portal may host machine learning module's 132 predictions and the associated confidence scores.

As will be discussed in more detail below, machine learning module 132 may update or retrain the machine learning model(s). Training may be tailored based on the task. For example, machine learning module 132 may train machine learning models to generate predictions regarding beverage system 110 and consumable product 112.

Regarding beverage system 110, the machine learning models may predict whether beverage system 110 is operating normally, has encountered an error, or requires preventative maintenance. Here, training may involve iterating over examples including sensor data and predicting: (1) whether the sensor data indicates beverage system 110 is encountering an error and/or requires preventative maintenance; and (2) predicting an action to address the error and/or preventative maintenance. Each example may have a corresponding label listing the condition (e.g., error present, preventative maintenance required) in the sensor data, and a correct action to take

Regarding consumable product 112, machine learning module 132 may one or more machine learning models to increase sales of consumable product 112. This may be accomplished by predicting one or more actions such as restocking consumable product 112, replacing a type of consumable product 112 at beverage system 110, updating the planogram at beverage system 110, and/or moving beverage system 110. Here, training may involve iterating over examples including sensor 114 data, sales data, customer data, and consumer survey data. Examples may also include internet data such as news information, traffic information, public events, and social media data. For each example, the models may be prompted to predict an action, such as whether to order more a specific consumable product 112 or to move beverage system 110. Each example may have a label listing the correct action to take. An error may be calculated based off of the model's prediction, and the correct action. The error may be used to correct the model.

Machine learning module 132 may retrain the model at any frequency. For example, training may occur daily, weekly, or monthly.

In some embodiments, a legacy beverage system 110 may be upgraded by installing sensors 114, sensor aggregator device 115, and communication device 116-1. Sensor aggregator device 115 and communication device 116-1 may be programmed using object-oriented modules to enable communication with each other as well as sensor(s) 114.

Client device 140 may be any entity attempting to communicate with beverage system 110 and/or cloud server 130. Client device 140 may be located at the edge of network 120. Although a single client device 140 is depicted, beverage equipment environment 100 may include multiple client devices 140. Client devices 140 may be deployed throughout a local, regional, national, and/or global network. Client device 140 may be a computer system such as computer system 700 described with reference to FIG. 7. Client device 140 may be a client system such as a desktop workstation, laptop or notebook computer, netbook, tablet, smart phone, and/or other computing device that may be using an enterprise computing system.

Client device 140 includes communication device 116-3, and display device 142. Communication device 116-3 may be configured to communicate with beverage system 110 and cloud server 130 via network 120. Communication device 116-3 may comprise any suitable network interface capable of transmitting and receiving data, such as, for example a modem, an Ethernet card, a communications port, or the like. Communication device 116-3 may be able to transmit data using any wireless transmission standard such as, for example, Wi-Fi, Bluetooth, cellular, or any other suitable wireless transmission. Display device 142 may be configured to display information at client device 140. Display device 142 may be configured to receive interactions from a user. An interaction may be a click, a button press, a swipe, etc.

Client device 140 may interact with cloud server 130 via network 120. Client device 140 may be required to create an account in order to provide computer and network security. For example, when client device 140 connects to cloud server 130, client device 140 may be prompted to provide credentials (e.g., username and password). In some embodiments, client device 140 may provide credential in the form of biometrics. For example, client device 140 may submit an image of a user's face, fingerprint, voiceprint, or any other biometric indicator. In some embodiments, cloud server 130 may limit functionality based on the credentials received. For example, a first client device 140 associated with a repair entity may connect to the portal at cloud server 130 and only be able to view completed and pending repair jobs involving beverage system 110. A second client device 140 may be associated with a regional sales manager. Here, the second client device 140 may be able to view a list of beverage systems 110 within the manager's area of responsibility, and associated data such as beverage system's 110 statuses, consumable products 112 at each system, sales information for each beverage system 110.

In some embodiments, client device 140 may send commands using the portal to cloud server 130 and/or beverage system 110. As discussed above, machine learning module 132 at cloud server 130 may generate various predictions relating to beverage system 110 and/or consumable product 112. In some embodiments, the predictions may involve taking one or more actions. For example, machine learning module 132 may predict, based on an upcoming sporting event, a first consumable product 112 should be restocked prior to its scheduled restock date. In some embodiments, cloud server 130 may send generated predictions to client device 140 for input. For example, cloud server 130 may send the restock order to client device 140 for confirmation. Client device 140 may send an approval or denial of the restock order (e.g., predicted action) to cloud server 130. As discussed above, machine learning module 132 may predict multiple actions, each assigned a probability. Here, cloud server 130 may send the list of predicted actions and their corresponding probabilities to client device 140. Here, client device 140 may select an action to execute. For example, machine learning module 132 may predict that a motor at beverage system 110 has failed based on rising temperatures detected by sensor 114. In response, machine learning module 132 may predict and second multiple actions to client device 140, such as: (1) power cycle beverage system 110; (2) disable internal lighting; and (3) contact external entity for repair. Here, client device 140 may select an action for cloud server 130 to initiate.

In some embodiments, client device 140 may receive alerts or notifications from cloud server 130. As discussed above, one form of an alert may be predicted actions based on data from beverage system 110. Additionally, client device 140 may be associated with an external entity and receive an alert regarding beverage system 110. In some embodiments, client device 140 may be associated with a part supplier (e.g., a store) that has access to a new or replacement part needed by beverage system 110. Client device 140 may be associated with a repair entity contacted to perform repair and/or preventative maintenance on beverage system 110. Client device 140 may be associated with law enforcement in a situation where beverage system 110 and/or consumable product 112 has been damaged or stolen. Additionally, client device 140 may be associated with a delivery entity responsible for restocking consumable product 112 at beverage system 110.

Cloud server 130 may be configured to execute actions automatically, without input from client device 140. For example, cloud server 130 may be configured to generate an invoice to deliver additional consumable products 112 to beverage system 110, and send the invoice to a delivery entity. In some embodiments, the delivery entity may receive the invoice via client device 140. The delivery entity may further be able to view the invoice at the portal hosted by cloud server 130.

Client device 140 may be associated with beverage system 110. For example, client device 140 may be linked to beverage system 110 by scanning a barcode or registering an identifier associated with beverage system 110. As another example, client device 140 may establish the link by accessing an online portal and inputting beverage system's 110 identifier. As a result, client device 140 may receive alerts or notifications from beverage system 110. For example, if beverage system 110 encounters an error or requires preventative maintenance, beverage system 110 may send a notification or alert to subscriber client devices 140 (e.g., linked client devices 140). Similarly, if consumable product 112 needs to be restocked or has higher sales than on average, cloud server 130 may alert client device 140.

Inventory system 150 may be implemented using one or more servers and/or databases. In some embodiments, inventory system 150 may be implemented using a computing device such as a desktop workstation, laptop or notebook computer, netbook, tablet, smart phone, and/or other computing device. In some embodiments, inventory system 150 may be implemented as an application in an enterprise computing system and/or a cloud-computing system. In some embodiments, inventory system 150 may be a computer system such as computer system 700 described with reference to FIG. 7. Although a single inventory system 150 is depicted, beverage equipment environment 100 may include multiple inventory systems 150. Inventory system 150 may be located at the edge of network 120.

Inventory system 150 may be a system configured to track past, current, and expected (e.g., future) inventory levels. The inventory levels may relate to consumable product 112. Inventory system 150 may include or be in connection with one or more manufacturing plants, warehouses, and distribution centers. Inventory system 150 may be configured to provide information related to: raw materials, consumable products 112 that are ready to ship, consumable products 112 in transit with expected delivery information, and delivered consumable products 112. Inventory system 150 may provide inventory information over network 120.

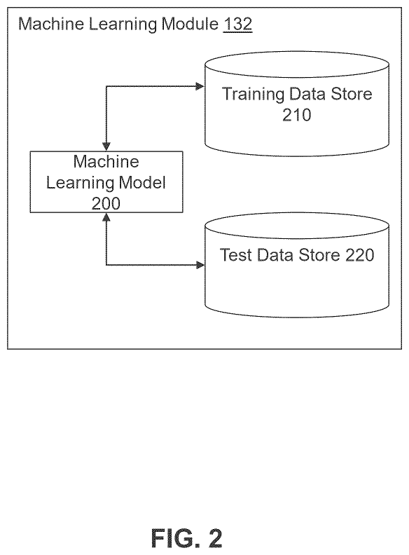

FIG. 2 depicts a block diagram of a machine learning module 132, according to some embodiments. Machine learning module 132 includes machine learning model 200, training data store 210, and test data store 220. Although a single machine learning model 200 is depicted, machine learning module 132 may include more than one machine learning model 200. Although training data store 210 and test data store 220 are depicted as separate entities, they may reside within the same memory storage device.

Additionally, training data store 210 and test data store 220 may be equal (e.g., include the same data), disjoint (e.g., include distinct data in each store), or overlapping (e.g., some data is present in both stores).

Machine learning model 200 may be any machine learning model to analyze data from sensor 114, consumable product 112 data, the internet, customer data, and inventory system 150. For example, machine learning model 200 may be a perceptron, support vector machine, neural network, convolutional neural network, generative adversarial network, large language model, transformer model, or recurrent neural network. Machine learning model 200 may incorporate any combination of models. This may be beneficial because different models may be optimized for different tasks. For example, machine learning model 200 may include a convolutional neural network to analyze image or video data from camera sensor 114, and a feed forward neural network to analyze sales data for consumable product 112.

Machine learning model 200 may be configured to input sensor data and predict a condition of beverage system 110 based on the sensor data. The condition may relate to whether beverage system 110 is operating normally, has encountered an error state, or requires preventative maintenance. Machine learning model 200 may predict the condition by performing pattern recognition. For example, machine learning model 200 may include an internal representation for each type of sensor data it is configured to analyze. The internal representations may be stored as numerical vectors or n-dimensional matrices, corresponding to features machine learning model 200 is configured to learn. For example, the features may be sensor data values and how they relate to aspects of beverage system's 110 operation. In some embodiments, sensor data may be categorized including normal values, error values, or values indicating preventative maintenance is required. When sensor data is received, data from each sensor may be compared to machine learning model's 200 internal representation of that sensor data. Based on the comparison, machine learning model 200 may predict a condition of beverage system 110. For example, machine learning model 200 may receive temperature, humidity, noise, vibration, and magnetism data. Machine learning model 200 may analyze the sensor data types and their respective values to predict whether they indicate a condition (e.g., normal, error, or preventative maintenance) at beverage system 110. As an additional example, machine learning model 200 may be configured to predict, based on received sensor data, whether a door at beverage system 110 is open. Additionally, machine learning model 200 may be configured to predict whether a compressor at beverage system 110 is operating normally. As an additional example, machine learning model 200 may be configured to predict whether a temperature of beverage system 110 and/or consumable product 112 is within normal limits. In some embodiments, machine learning model 200 may be configured to predict actions to improve energy usage such as dimming internal lights during the day and reducing air conditioning usage at night.

Machine learning model 200 may be further configured to predict actions, based on the predicted condition. If machine learning model 200 predicts that beverage system 110 is operating normally and does not require preventative maintenance, machine learning model 200 may predict that no action is needed. If machine learning model 200 predicts beverage system 110 is encountering an error and/or requires preventative maintenance, machine learning model 200 may predict an action to repair the error and/or perform the maintenance. Similar to the conditions, machine learning model 200 may predict multiple actions for a given set of sensor data. The actions may be predicted according to a probability distribution. Each probability may correspond to machine learning model's 200 confidence that the action is correct given the predicted condition.

Machine learning model 200 may be further configured to input sensor 114, consumable product 112 data, the internet, customer data, and inventory system 150, in order to predict conditions related to consumable product 112 and beverage system 110. For example, machine learning model 200 may include internal representations relating to consumable sensor 114, consumable product 112, beverage system 110, internet data, customer data, and inventory system 150. For example, machine learning model 200 may include numerical vectors or n-dimensional matrices, corresponding to relationships between data regarding consumable sensor 114, consumable product 112, beverage system 110, internet data, customer data, and inventory system 150 that machine learning model 200 is configured to learn.

Machine learning model 200 may include representations for relationships between various pieces of information such as sensor 114 data, consumable product 112 data, beverage system 110 data, inventory system 150 data, customer data, and internet data (e.g., social media, traffic, and public events). For example, machine learning model 200 may learn an association between geographic locations and the rate of sales for certain consumable products 112. For example, a first consumable product 112 may sell at a higher rate at a university than at an elementary school. Machine learning model 200 may further learn an association between the time of day, day of week, and types of consumable products 112. For example, a first consumable product 112 (e.g., coffee) may sell at a higher rate in the morning on weekdays than in the evening on weekdays. Similarly, a second consumable product 112 (e.g., soda) may sell at a higher rate in the evening, any day of the week, as compared to the morning.

Machine learning model 200 may further learn which consumable products 112 sell the most at which location within beverage system 110. As discussed above, a planogram may be used to identify where a consumable product 112 is located within beverage system 110. Here, the machine learning model 200 may include a representation for where a consumable product 112 sells most within beverage system 110.

Machine learning model 200 may further include representation between events and consumable product 112 sales. For example, machine learning model 200 may learn that specific performing artists or professional sporting events are correlated with increase sales of certain consumable products 112.

Machine learning model 200 may further learn correlation between social media trends and consumable products 112. Machine learning model 200 may determine that when certain topics are trending on social media, sales of consumable product 112 are impacted. For example, machine learning model 200 may associate healthy eating or dieting social media trends with increased sales of juice as compared with soda. Machine learning model 200 may be configured to learn the interrelationships of any combination of factors discussed above. For example, machine learning model 200 may be configured to correlate consumable product 112 sales with location, time of day, day of the week, and social media trends.

Machine learning model 200 generate predictions regarding consumable product 112 and/or beverage system 110 based on correlations identified within input data. For example, machine learning model 200 may predict to restock consumable product 112 based off of an upcoming sporting event or social media trend. Machine learning model 200 may predict that a first consumable product 112 at beverage system 110 should be swapped with a second consumable product 112. Machine learning model 200 may predict an updated planogram for beverage system 110. This may be based off of, for example, the types of consumable product 112 at beverage system 110, a current rate of sales, beverage system's 110 location, data of a customer that purchased consumable product 112 at beverage system 110, and an upcoming concert nearby. In some embodiments, machine learning model 200 may predict that beverage system 110 should be moved to increase sales. For example, machine learning model 200 may predict that another area near beverage system 110 has more foot traffic and that if beverage system 110 were in that area instead, it would generate increased sales. Machine learning model 200 may further predict any combination of the actions described above. For example, machine leaning model 200 may predict to both: (1) restock consumable product 112; and (2) update beverage system's 110 planogram.

In some embodiments, machine learning module 132 may utilize multiple machine learning models 200. For example, machine learning module 132 may include a first machine learning model 200-1 configured as a large language model (LLM), and a second machine learning model 200-2 configured as a large action model (LAM). The LLM may be configured to input data and make a prediction regarding beverage system 110 and/or consumable product 112. For example, LLM may predict a repair and/or preventative maintenance status of beverage system 110, a new planogram for consumable product 112 at beverage system 110, a new type of consumable product 112 to stock at beverage system 110, a new orientation of beverage system 110, a new location of beverage system 110, or any combination thereof. The LLM may be further configured to predict a time, route, or any combination thereof, to interact with beverage system 110. For example, the LLM may predict the best time to restock consumable product 112 at beverage system 110 based on time of sales made at beverage system 110.

The LAM may input the LLM's output to predict and execute one or more actions. Stated differently, the LAM may input the LLM's prediction, and generate a sequence of actions in order to implement the LLM's prediction. Similar to the LLM, the LAM may input data from any source (e.g., the internet, customer data, inventory system 150, beverage system 110) in addition to the LLM's prediction. The LAM may initiate the sequence of actions. For example, the LAM may generate messages (e.g., alerts, restock orders, repair orders, commands) and send them from cloud server 130 to entities on network 120. For example, the LAM may be configured to adjust prices for consumable product 112 at beverage system 110 by sending a command to beverage system 110 including adjusted prices for consumable product 112. Commands may also include actions regarding the components of beverage system 110. For example, the LAM may generate and send a command to beverage system 110 to modify the functioning of its cooling system, lighting system, power system, or any other system or component at beverage system 110. For example, the LAM may generate and send a command to beverage system 110 to temporarily disable Wi-Fi and cellular sensors at beverage system 110. In some embodiments, beverage system 110 may be configured to update its planogram. Here, the LAM may send a command to beverage system 110 to implement an updated (e.g., recommended) planogram. The LAM may further generate and submit an invoice to a third party client device 140 to restock consumable product 112 at beverage system 110. Additionally, the LAM may search an internal database for a repair entity associated with beverage system 110. The LAM may also search external sources such as the internet or a list of preferred vendors for repair entities located near beverage system 110. The LAM may be further configured to contact the repair entity to perform maintenance and/or repairs on beverage system 110.

The LAM may send alerts to cloud server 130 for posting to the portal. The LAM may send alerts to entities responsible for repairing and/or performing preventative maintenance on beverage system 110. For example, the LAM may transmit alerts to client device 140 associate with a repair entity. In some embodiments, the LAM may send commands directly to beverage system 110. For example, the LAM may send a command to beverage system 110 to adjust its temperature, lighting, or any other system.

Machine learning model 200 may use training data store 210 and test data store 220 for training and testing purposes. Training data store 210 may be implemented using a memory storage device. Training data store 210 may include data used to train machine learning model 200. Training data store 210 may include various types of data.

Regarding repairs, training data store 210 may include sensor data, actions taken in response to the sensor data, and results. The sensor data may be labelled to identify which sensor 112 the data came from. The sensor data may additionally be labeled with whether the data includes a condition, such as an error. For example, sensor data may be labeled as normal, an error, or requiring preventative maintenance. The result may indicate whether the actions addressed the sensor data successfully or not. The result may be a binary value such as “true/false,” or “0/1.” In some embodiments, the result may be a value such as a percentage indicating the effectiveness of the action.

Machine learning model 200 may train on data at training data store 210. Machine learning model 200 may train to accomplish two goals. First, machine learning model 200 may train to identify a condition within the sensor data. In some embodiments, the condition may indicate an error at beverage system 110. The condition may also indicate that preventative maintenance is required. At this stage, machine learning model 200 may input sensor data and generate an output. The output may be a single value corresponding to a condition in the sensor data. In some embodiments, the output may be a probability distribution over one or more conditions. For example, machine learning model 200 may detect four conditions in the sensor data, and assign them each a probability score. The output may be compared to a label. The label may be the actual condition present in the sensor data. An error may be calculated based on the difference between the output and the label. The calculated error may be used to update machine learning model 200. In some embodiments, machine learning model 200 may be updated using backpropagation.

Second, machine learning model 200 may be trained to predict actions addressing the identified condition(s). Here, machine learning model 200 may input sensor data and output an action. The action may be based on a condition identified within the sensor data. In some embodiments, machine learning model 200 may be given the condition within the sensor data. This may be advantageous to prioritize resources towards improving machine learning model's 200 ability to predict correct actions. In some embodiments, machine learning model 200 may not be given the condition. Here, machine learning model 200 may predict the condition and the action. The output action may be a single value (e.g., a single action to perform). In some embodiments, the output may be a probability distribution over a set of actions. The probability may correspond to machine learning model's 200 confidence in each action. The output actions may be compared to a label for the sensor data. The label may be the correct action to address the condition within the sensor data. An error between the output action and label may be calculated and used to update machine learning model 200.

Regarding consumable product 112, training data store 210 may include examples of sensor data, consumable product 112 data, beverage system 110 data, internet data (e.g., local weather data), inventory system 150 data, and customer data. In some embodiments, an example may include data from any combination of sources described above. For example, a single example may include consumable product's 112 sales rate, beverage system's 110 location, beverage system's 110 planogram, upcoming events near beverage system 110, and expected restock date for consumable product 112. Training data store 210 may further include actions taken in response to the data, and results. For example, the action may be an updated planogram. A result may be whether the action increased sales of consumable product 112.

Similar to the process described above, machine learning model 200 may input training data examples and predict actions such as ordering more of consumable product 112, ordering a different type of consumable product 112, moving beverage system 110 to a different location. The predicted action may be compared to the action associated with the training data example. An error may be calculated based on a difference between the predicted action and the labeled action. The error may be used to update machine learning model 200. As a result, machine learning model 200 may be better able to identify actions likely to increase consumable product's 112 sales.

Machine learning model 200 may use test data store 220 for testing and validation purposes. For example, once machine learning model 200 trains on training data store 210, it may use the data at test data store 220 to evaluate its performance. Machine learning model 200 may use test data store 220 by generating predictions for data at test data store 220. Each prediction may be compared against a ground truth label in order to determine machine learning model's 200 accuracy. Testing may involve the same steps as the training process described above, except that machine learning model 200 is not updated based on the results.

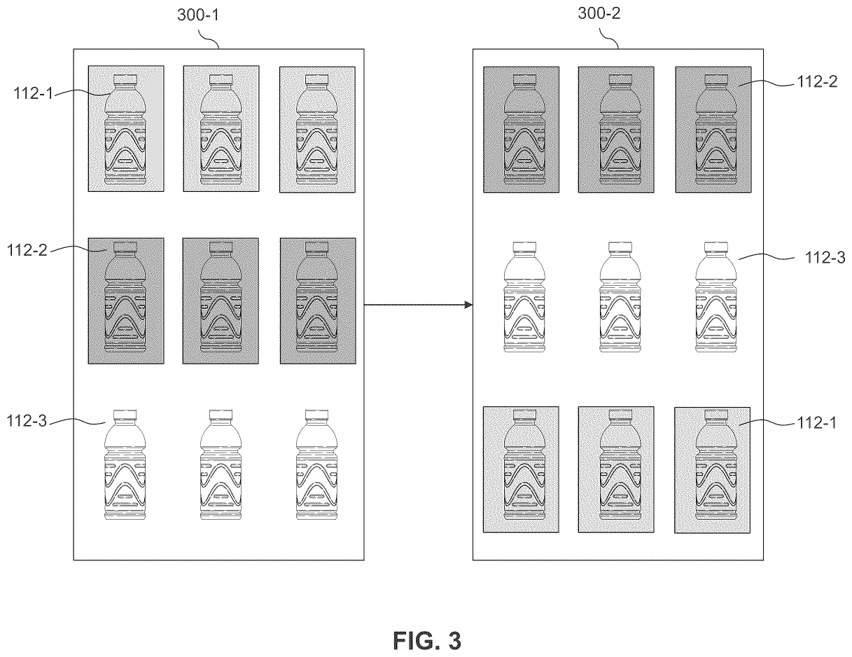

FIG. 3 depicts an exemplary beverage equipment planogram 300. As described above, a planogram, such as planogram 300, may be used to describe the layout of consumable product 112 within beverage system 110. For example, a planogram may be used to determine which product is located where within beverage system 110. Planogram 300-1 may include first consumable product 112-1, second consumable product 112-2, and third consumable product 112-3. As shown in FIG. 3 and according to planogram 300-1, first consumable product 112-1 may be positioned at the top, second consumable product 112-2 may be positioned in the middle, and third consumable product 112-3 at the bottom.

As discussed above, planogram 300 may be updated based on a prediction by machine learning module 132. For example, machine learning module 132 may input sensor 114 data, consumable product 112 sales data, customer data, and internet data, and produce an updated planogram (e.g., planogram 300-2). Planogram 300-2 may be generated based on a prediction that it will lead to increased sales. Planogram 300-2 may include an updated layout of consumable products 112. For example, consumable product 112-2 may now be positioned at the top, consumable product 112-3 at the middle, and consumable product 112-1 at the bottom.

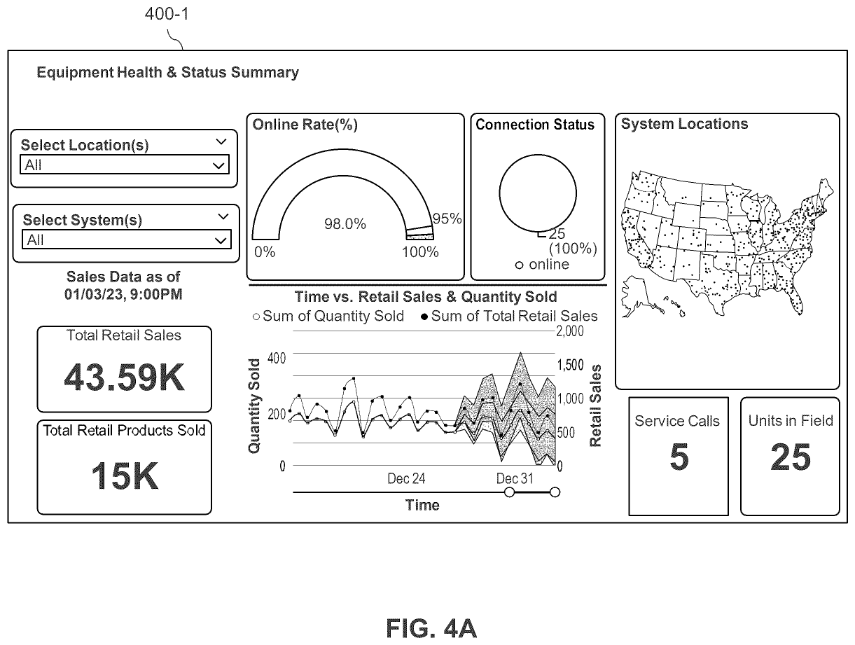

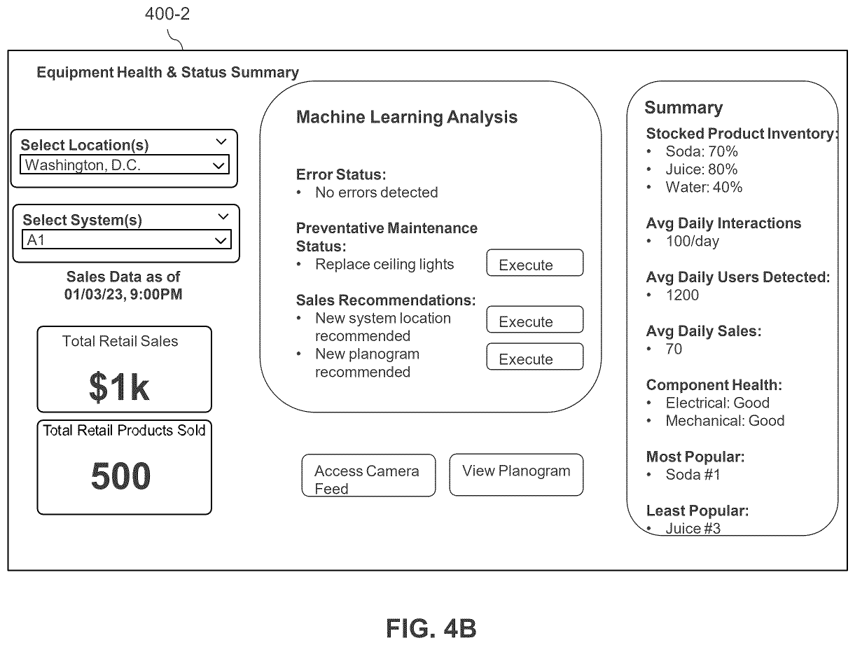

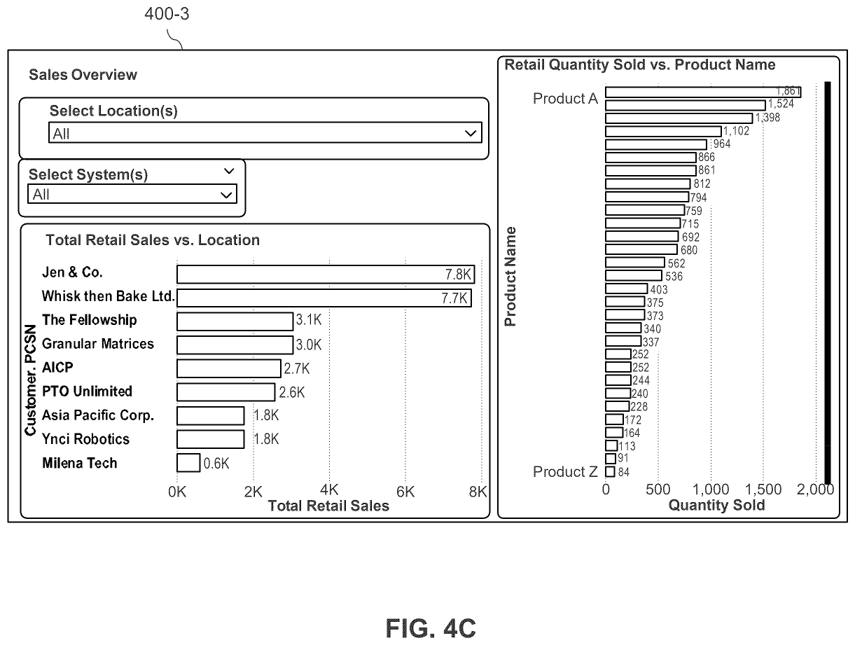

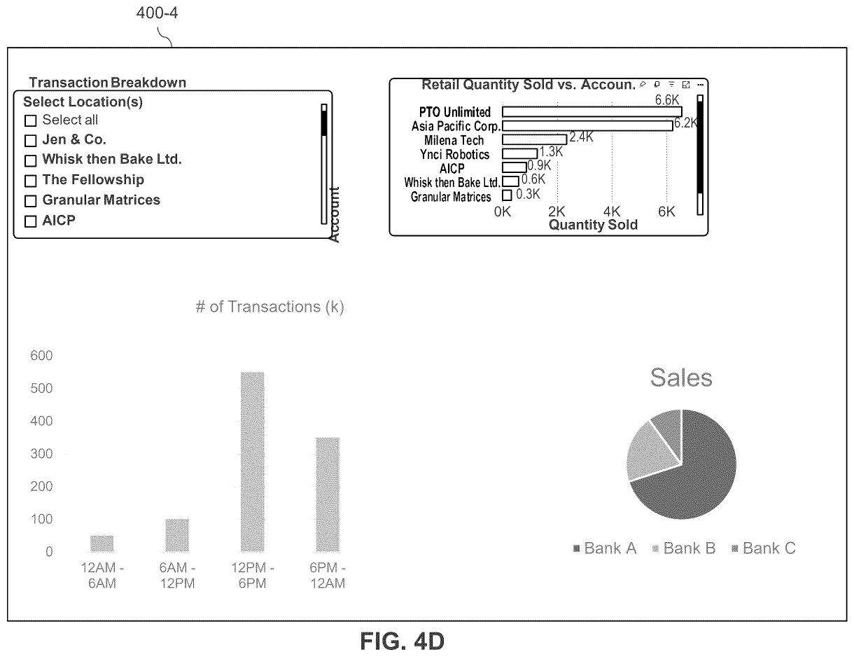

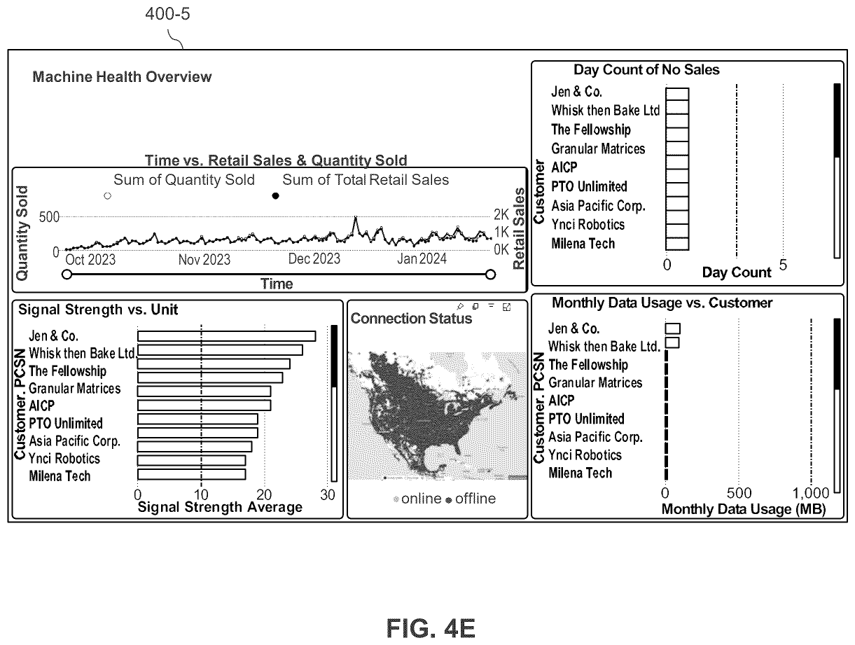

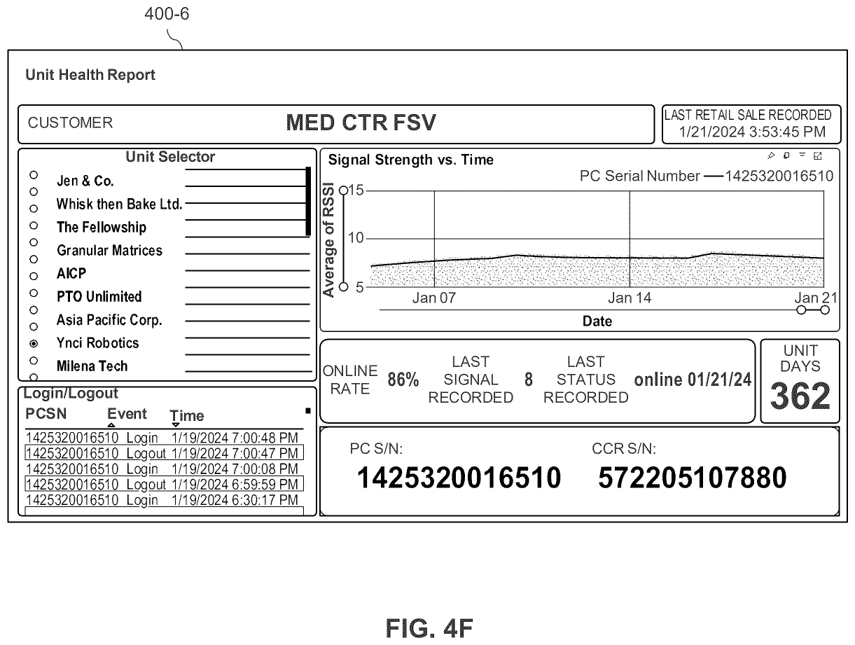

FIG. 4A depicts an exemplary interface 400-1 for a service, sales, and consumer analytics portal, according to some embodiments. The portal may be hosted by cloud server 130. Interface 400-1 may be displayed at client device 140 when it connects to cloud server 130. Interface 400-1 may display various metrics such as a map of beverage systems 110, a total number of beverage systems 110, a number of repair service calls made, and a percent beverage systems 110 online. Interface 400-1 may further display sales data such as total retail sales, number of retail products (e.g., consumable product 112) sold, and sales information over time. Interface 400-1 may display a filter by location feature. When interacted with, interface 400-1 may update to include data for the selected location.

FIG. 4B depicts an exemplary interface 400-2 for a service, sales, and consumer analytics portal, according to some embodiments. The portal may be hosted by cloud server 130. Interface 400-2 may be displayed at client device 140 when it connects to cloud server 130. Interface 400-2 may display data for a selected beverage system 110. For example, a user at client device 140 may select a location, and a beverage system 110 (e.g., A1) assigned to the selected location. Interface 400-2 may show retail sales and a total number of consumable products 112 sold for the selected beverage system 110. Interface 400-2 may further display analysis generated by machine learning module 132. For example, interface 400-2 may display whether machine learning module 132 detects beverage system 110 has encountered an error. Interface 400-2 may further display whether beverage system 110 requires preventative maintenance. For example, machine learning module 132 may analyze sensor 114 data to determine that the ceiling lights at beverage system 110 should be replaced. Interface 400-2 may further display analysis regarding consumable product 112. For example, machine learning module 132 may have input consumable product 112 sales data, internet data, sensor 114 data, customer data, and inventory system 150 data to determine that beverage system 110 should be moved to a new location and that a new planogram should be implemented.

Interface 400-2 may further include a button allowing a user at client device 140 to initiate the recommended action. For example, interface 400-2 may display a button labeled “Execute” next to each recommended action. When the button is pressed or otherwise interacted with, cloud server 130 may send an alert or notification to an entity associated with the action. For example, repair actions may result in notifications being sent to client devices 140 associated with repair entities. In some embodiments, repair actions may further result in orders for new or replacement parts being ordered. For example, when the “Execute” button next to “Replace ceiling lights” is pressed, cloud server 130 may place an order for replacement ceiling lights. In some embodiments, cloud server 130 may send the replacement lights to an entity responsible for servicing beverage system 110. When sales recommendations are interacted with, cloud server 130 may send alerts or notifications to entities responsible for implementing the recommendation. For example, when “New system location” is interacted with, an alert may be sent to an entity capable of moving beverage system 110. Similarly, when “New planogram” is interacted with, an alert may be sent to an entity capable of updating the planogram at beverage system 110. In some embodiments, beverage system 110 may be configured to automatically update its planogram via one or more movable shelves. Here, cloud server 130 may send the planogram directly to beverage system 110.

Interface 400-2 may further display a summary of the selected beverage system 110 (e.g., A1). The summary may include stocked product inventory. The stocked product inventory may list percentage of the listed item's inventory. For example, the summary may indicate that 70% of beverage system's 110 soda inventory is available. The summary may further include an average number of daily interactions. This may be determined based on the number of users that interact with beverage system 110. In some embodiments, this may be the total number of users that interact with beverage system 110, whether they purchase consumable product 112 or not. The summary may further include an average number of users detected per day. This may be based off of sensor 114 data such as from images, video, audio, cellular signals, Wi-Fi signals, Bluetooth signals, RFID signals, and/or NFC signals. The summary may further include an average number of daily sales. For example, beverage system 110 may perform 70 transactions on average each day. The summary may further include component health of beverage system 110. For example, the summary may list status regarding beverage system's 110 electrical and mechanical systems. These determinations may be based off of machine learning module 132 analysis of sensor 114 data. The summary may further list most popular and least popular consumable products 112 at beverage system 110.

Interface 400-2 may further include an ability to access a camera feed at beverage system 110. When pressed, images, video, and/or audio data collected by sensor 114 at beverage system 110 may be shown at the portal. This may be beneficial in a scenario where beverage system 110 has been stolen or is encountering a critical error. Interface 400-2 may further include an ability to who beverage system's 110 current planogram to show where consumable products 112 are located within beverage system 110.

FIG. 4C depicts an exemplary interface 400-3 for a service, sales, and consumer analytics portal, according to some embodiments. The portal may be hosted by cloud server 130. The portal may be hosted by cloud server 130. Interface 400-3 may be displayed at client device 140 when it connects to cloud server 130. Interface 400-3 may display sales based on location. For example, beverage systems 110 may be located in various establishments, and interface 400-3 may display rate of sales by location. Interface 400-3 may further display data of which types of consumable products 112 are sold. For example, interface 400-3 lists products A-Z and a quantity of each sold. Interface 400-3 may also display a location filter feature.

FIG. 4D depicts an exemplary interface 400-4 for a service, sales, and consumer analytics portal, according to some embodiments. The portal may be hosted by cloud server 130. Interface 400-4 may be displayed at client device 140 when it connects to cloud server 130. Interface 400-4 may display quantity of consumable product 112 sold at each location where beverage system 110 is located. Interface 400-4 may further show banks associated with transactions made at beverage system 110. For example, interface 400-4 may display a pie chart indicating proportions of transactions executed via Bank A, Bank B, and Bank C. Interface 400-4 may further display a number of transactions occurring by time period (e.g., 12 AM-6 AM, 6 AM-12 PM, etc.) Interface 400-4 may also display a location filter feature.

FIG. 4E depicts an exemplary interface 400-5 for a service, sales, and consumer analytics portal, according to some embodiments. The portal may be hosted by cloud server 130. Interface 400-5 may be displayed at client device 140 when it connects to cloud server 130. Interface 400-5 may display sum quantity of consumable product 112 sold. Interface 400-5 may also display data usage by beverage system 110 when it communicates with cloud server 130. Interface 400-5 may further display average signal strengths of beverage systems 110 at various locations. The signal may be the signal connecting beverage system 110 with cloud server 130 via network 120. Interface 400-5 may include a map showing beverage systems 110 currently connected to cloud server 130.

FIG. 4F depicts an exemplary interface 400-6 for a service, sales, and consumer analytics portal, according to some embodiments. The portal may be hosted by cloud server 130. Interface 400-6 may be displayed at client device 140 when it connects to cloud server 130. Interface 400-6 may display beverage systems 110 associated with a customer. For example, a customer associated with client device 140 may access the portal, and view interface 400-6. The customer may be able to view a list of locations where they own or manage beverage systems 110. The customer may be able to select a location to access information associated with beverage system 110 at the location. Interface 400-6 may update to show that beverage system's 110 signal strength over time, the last time its status was recorded, the number of days that beverage system 110 has been at the location. Interface 400-6 may further show the last time that beverage system 110 made a sale.

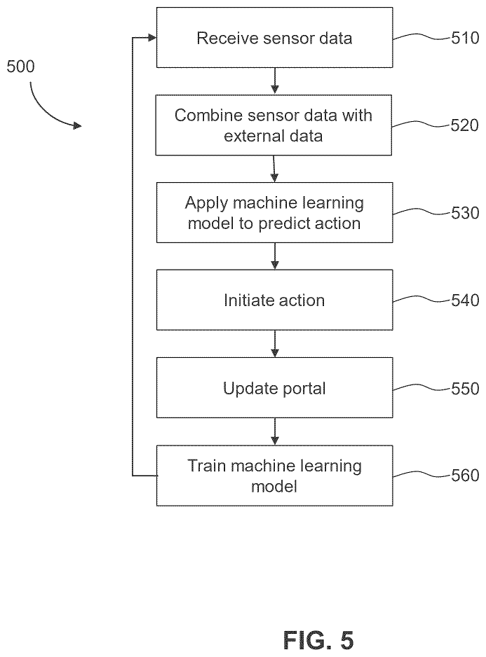

FIG. 5 depicts a flowchart illustrating a method 500 for using sensor data to take an action, according to some embodiments. Method 500 shall be described with reference to FIG. 1, however, method 500 is not limited to that example embodiment.

In an embodiment, beverage system 110 and/or cloud server 130 may utilize method 500 to analyze sensor data and external data. The data may be used to generate predictions regarding beverage system 110 and/or consumable product 112. The foregoing description will describe an embodiment of the execution of method 500 with respect to beverage system 110 and/or cloud server 130. While method 500 is described with reference to beverage system 110, method 500 may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5.

At 510, beverage cloud server 130 receives sensor data. The sensor data may originate from sensor 114 at beverage system 110. As discussed above, sensor 114 may be camera (internally and/or externally facing), thermometer, accelerometer, humidity sensor, noise sensor (e.g., a microphone), magnetometer, voltmeter, electrical current sensor, light sensor, infrared (IR) sensor, vibration sensor, GPS, flowmeter, tilt detector, loadcell, or proximity sensor, but is not limited to the sensor types listed. Sensor 114 may be a wireless access point, cellular base station, Bluetooth receiver, RFID device, or NFC device.

The sensor data may include foot traffic data, eye tracking data, and geolocation of beverage system 110 data. Foot traffic data may include data used to estimate a number of users passing near beverage system 110. This may be based on image data, video data, and/or audio data. This may further be based on signal data such as Wi-Fi, cellular, Bluetooth, RFID, and/or NFC data. Eye tracking data may indicate consumable product 112 that a user looked at and a corresponding duration. Geolocation data may include GPS coordinates of beverage system 110.

At 520, cloud server 130 combines the sensor reading with external data. In some embodiments, the cloud server 130 may also include other sensor readings. For example, cloud server 130 may combine readings from multiple sensors 114. The external data may be any information that cloud server 130 has access to. The external data may include, internet data such as weather, traffic, news, social media, and public event data. The external data may further include data from inventory system 150 such as estimated restock times. The external data may also include data regarding consumable product 112. This may include a name of consumable product 112, a number of consumable products 112 at beverage system 110, current price of consumable product 112, total consumable product 112 sales, daily average consumable product 112 sales, and a number of consumable products 112 sold. The external data may further include customer data. Customer data may be data associated with a customer that purchased consumable product 112. For example, customer data may include age, sex, occupation, salary, home address, and/or education. In some embodiments, cloud server 130 may create a single matrix including the received sensor 114 data and external data. This may be beneficial to generate a prediction based off of a single input.

At 530, cloud server 130 applies a machine learning model to predict an action based on the combined data. In some embodiments, cloud server 130 may utilize one or more machine learning models at machine learning module 132 to predict the action. In some embodiments, the action may be related to the status of beverage system 110. For example, the action may be whether beverage system 110 needs to be repaired or requires preventative maintenance. As a further example, the action may be to alert an entity responsible for beverage system 110 and/or the authorities, based on a determination that beverage system 110 has been moved. In some embodiments, the action may relate to consumable product 112. For example, the action may be to restock consumable product 112, update a planogram at beverage system 110, swap consumable products 112, and/or move beverage system 110 to a different location. In some embodiments, multiple actions may be predicted. Each predicted action may have a probability corresponding to the machine learning model's confidence in the action.

At 540, cloud server 130 initiates the action. In some embodiments, may initiate the action with the highest probability score. In some embodiments, cloud server 130 may initiate the action directly at beverage system 110. For example, if the action is to use a new planogram, beverage system 110 may be configured to automatically update its planogram to match the recommended planogram. Here, cloud server 130 may send the recommended planogram directly to beverage system 110. In some embodiments, beverage system 110 may be configured to automatically implement a repair action. For example, cloud server 130 may send a message to beverage system 110 indicating it should power cycle or deactivate a subsystem (e.g., fan, lighting system, or cooler). In some embodiments, cloud server 130 may initiate the action by interacting with a third party. For example, cloud server 130 may send the predicted action to client device 140 associated with beverage system 110. Client device 140 may be associated with an entity capable of addressing the action. For example, client device 140 may be associated with an entity capable of performing repairs, preventative maintenance, updating a planogram, restocking consumable product 112, swapping consumable products 112, or moving beverage system 110. For example, cloud server 130 may send an alert to client device 140 indicating that an inventory of consumable product 112 is below a predefined threshold and needs to be restocked. In some embodiments, the restock alert may further include a location of beverage system 110, consumable product 112 to be restocked, a restock quantity, and a recommended restock time. In some embodiments, cloud server 130 may determine a restock time based off of various factors, such as: (i) a time the consumable product is purchased, (ii) a geolocation of the beverage system, and (iii) traffic near the beverage system.

At 550, cloud server 130 updates a portal. As discussed above, the portal may be accessed by a device such as client device 140 connecting to cloud server 130. In some embodiments, the device may be required to provide credentials to access the portal. For example, a user associated with client device 140 may be required to input a username and password. Cloud server 130 may update the portal to display the received sensor and external data. Cloud server 130 may further update the portal to display the actions that the machine learning model(s) predicted. Cloud server 130 may further include the initiated action and an action status (e.g., in progress, completed, or canceled). In some embodiments, a user may cancel an action. For example, if cloud server 130 initiated an action to restock consumable product 112, the user may use the portal at cloud server 130 to cancel the restock action. The portal may further allow the user to select an alternate action to perform. For example, the user may use the portal to instead update beverage system's 110 planogram.

At 560, cloud server 130 trains the machine learning model. As stated above, the machine learning model may be machine learning model 200 at machine learning module 132. Cloud server 130 may train the machine learning model based on the action implemented. For example, if the action related to repairing or performing preventative maintenance on beverage system 110, cloud server 130 may collect sensor data to determine whether the action was successful. Cloud server 130 may use this data to train the machine learning model. For example, if the action was successful (e.g., repaired beverage system 110), cloud server 130 may use backpropagation to update a set of weights at the machine learning model associated with the initiated action and the received sensor data.

Similarly, cloud server 130 may have initiated an action regarding consumable product 112 such as changing the types of consumable products 112 at beverage system 110 or updating the planogram at beverage system 110. Here, cloud server 130 may continue to collect information from beverage system 110 such as sensor data and data regarding consumable product 112 such as sales data. Cloud server 130 may use the sensor and sales data to determine whether the action was successful or not, and train the machine learning model. As stated above, cloud server 130 may train the machine learning model by performing backpropagation to update a set of weights associated with the action.

In some embodiments, cloud server 130 may train the machine learning model each time an action is initiated. In some embodiments, cloud server 130 may train the machine learning model after a predetermined number of initiated actions or after a certain amount of time has passed.

Cloud server 130 may execute multiple instances of method 500 in parallel. For example, cloud server 130 may receive sensor data from multiple beverage system 110, and execute multiple instances of method 500 via a multi-threaded processor to analyze the sensor data.

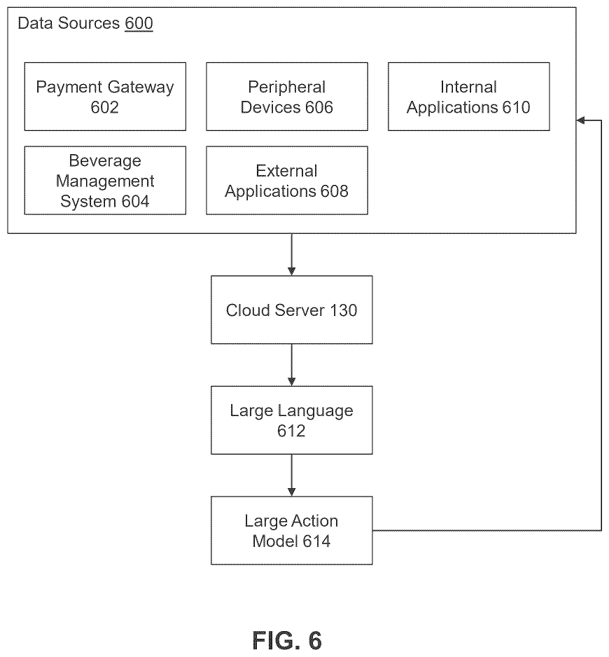

FIG. 6 depicts a block diagram of data inputs to cloud server 130, according to some embodiments. As depicted in FIG. 6, cloud server 130 may receive data from data sources 600. Data sources 600 may represent various systems configured to input data to cloud server 130. Data sources 600 may include, but is not limited to, payment gateway 602, beverage management system 604, peripheral devices 606, external applications 608, and internal applications 610.

Payment gateway 602 may collect and send cloud server 130 data regarding sales. For example, when a purchase is made at beverage system 110 using a credit card, debit card, or any electronic payment medium, payment gateway 602 may forward purchase information to cloud server 130. For example, payment gateway 602 may send the consumable product 112 purchased, the price, the date and time of purchase, the type of purchase instrument (e.g., debit card, credit card), and a bank associated with the purchase instrument.

Beverage management system 604 may send data to cloud server 130 including locations of beverage systems 110, and the planograms of beverage systems 110. Beverage system management 604 may further send sales data to cloud server 130. The sales may relate to beverage system 110. For example, payment gateway 602 may send cloud server 130 which consumable products 112 were purchased at which beverage system 110. Beverage management system 604 may further send profits for each sale.

Peripheral devices 606 data may include data collected by sensor 114. As noted above, sensor 114 may collect data regarding temperature, voltage, location, humidity, nearby objects, orientation, user interactions, images, video, audio, ambient light, cellular signals, Bluetooth signals, and Wi-Fi signals.

External applications 608 may refer to third party data sources accessible via network 120. For example, external applications 608 may refer to any data source on the internet. Data from external applications 608 may include data regarding traffic, social media, news, sporting events, concerts, and weather. In some embodiments, external applications 608 may provide customer data corresponding to a customer that purchased consumable product 112 from beverage system 110. For example, external applications 608 may be affiliated with a bank or financial institution. The bank or financial institution may regulate a credit card that the customer used to purchase consumable product 112.

Internal applications 610 may refer to data from entities associated with cloud server 130 and/or beverage system 110. For example, data from internal applications 610 may be from entities that own, manage, lease, and/or repair beverage system 110. Data from internal applications 610 may further include inventory information from inventory system 150.

In some embodiments, cloud server 130 may ingest data from data sources 600 and transmit it to large language model (LLM) 612. LLM 612 may be machine learning model 200 at machine learning module 132. LLM 612 may be trained to input the data and generate various predictions. For example, LLM 612 may predict real-time key performance indicators such as health/repair status of beverage system 110. LLM 612 may determine the location of beverage system 110. LLM 612 may predict reparative and/or preventative maintenance for beverage system 110. LLM 612 may predict a new placement and/or orientation of beverage system 110. Similarly, LLM 612 may predict a different set of consumable products 112 and/or a new planogram for consumable products 112 at beverage system 110. LLM 112 may further predict that certain consumable products 112 need to be restocked. LLM 112 may predict optimal times and/or routes to interact with beverage system 110 (e.g., move beverage system 110, reorient beverage system 110, restock beverage system 110, and update planogram at beverage system 110).

Large action model (LAM) 614 may input the output of LLM 612. LAM 614 may be trained to interact with entities via network 110 to implement predictions by LLM 612. For example, LAM 614 may be trained to adjust prices for consumable product 112 at beverage system 110. LAM 614 may generate and submit an invoice to restock consumable product 112 at beverage system 110. LAM 614 may send alerts to entities responsible for repairing and/or performing preventative maintenance on beverage system 110. LAM 614 may send commands directly to beverage system 110. For example, LAM 614 may send a command to beverage system 110 to adjust its temperature, lighting, or any other system.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, solid state drive, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, /d/ any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method, comprising:
receiving, at a computing device, data via a network, wherein the data includes at least one of sensor data from a beverage system located at an edge of the network, consumable product data from the beverage system located at the edge of the network, inventory system data, and internet data;
generating, by a machine learning model at the computing device, a prediction using the received data, wherein the prediction includes one of a repair action for a component at the beverage system, a preventative maintenance action for the component at the beverage system, or an action regarding the consumable product;
generating, by the machine learning model at the computing device, a sequence of one or more actions based on the generated prediction and the received data; and
initiating, by the computing device, the sequence of one or more actions by performing at least one of sending a message to a client device associated with the beverage system or sending a command to the beverage system.

2. The computer-implemented method of claim 1, wherein the sensor data includes: (i) foot traffic data surrounding the beverage system, (ii) eye tracking data indicating a consumable product and a duration a user looked at the consumable product, and (iii) a geolocation of the beverage system.

3. The computer-implemented method of claim 2, wherein the prediction comprises a recommended planogram for the beverage system, the recommended planogram based off of the sensor data, an amount the consumable product is purchased at the beverage system, and data of a customer that purchased the consumable product at the beverage system.

4. The computer-implemented method of claim 3, further comprising moving the consumable product within the beverage system to match the recommended planogram.

5. The computer-implemented method of claim 1, wherein the prediction comprises an alert that a quantity of the consumable product is below a predefined threshold.

6. The computer-implemented method of claim 5, wherein the prediction comprises a restocking order, the restocking order comprising: (i) a location of the beverage system; (ii) the consumable product to restock; (iii) a restock quantity; and (iv) a recommended restock time.

7. The computer-implemented method of claim 6, wherein the recommended restock time is based off (i) a time the consumable product is purchased, (ii) a geolocation of the beverage system, and (iii) traffic near the beverage system.

8. A system, comprising:
a memory; and
at least one processor coupled to the memory and configured to:
receive data via a network, wherein the data includes at least one of sensor data from a beverage system located at an edge of the network, consumable product data from the beverage system located at the edge of the network, inventory system data, and internet data;
generate, by a machine learning model at the computing device, a prediction using the sensor data and the consumable product data, wherein the prediction includes one of a repair action for a component at the beverage system, a preventative maintenance action for the component at the beverage system, or an action regarding the consumable product; and
generate, by the machine learning model at the computing device, a sequence of one or more actions based on the generated prediction and the received data; and
initiate, by the computing device, the sequence of one or more actions by performing at least one of sending a message to a client device associated with the beverage system or sending a command to the beverage system.

9. The system of claim 8, wherein the sensor data includes: (i) foot traffic data surrounding the beverage system, (ii) eye tracking data indicating a consumable product and a duration a user looked at the consumable product, and (iii) a geolocation of the beverage system.

10. The system of claim 9, wherein the prediction comprises a recommended planogram for the beverage system, the recommended planogram based off of the sensor data, an amount the consumable product is purchased at the beverage system, and data of a customer that purchased the consumable product at the beverage system.

11. The system of claim 10, wherein the at least one processor is further configured to move the consumable product within the beverage system to match the recommended planogram.

12. The system of claim 8, wherein the prediction comprises an alert that a quantity of the consumable product is below a predefined threshold.

13. The system of claim 12, wherein the prediction comprises a restocking order, the restocking order comprising: (i) a location of the beverage system; (ii) the consumable product to restock; (iii) a restock quantity; and (iv) a recommended restock time.

14. The system of claim 13, wherein the recommended restock time is based off (i) a time the consumable product is purchased, (ii) a geolocation of the beverage system, and (iii) traffic near the beverage system.

15. A non-transitory computer-readable device having instructions stored thereon that, when executed by at least one computing device, cause the at least one computing device to perform operations comprising:
receiving, at a computing device, data via a network, wherein the data includes at least one of sensor data from a beverage system located at an edge of the network, consumable product data from the beverage system located at the edge of the network, inventory system data, and internet data;
generating, by a machine learning model at the computing device, a prediction using the received data, wherein the prediction includes one of a repair action for a component at the beverage system, a preventative maintenance action for the component at the beverage system, or an action regarding the consumable product;
generating, by the machine learning model at the computing device, a sequence of one or more actions based on the generated prediction and the received data; and
initiating, by the computing device, the sequence of one or more actions by performing at least one of sending a message to a client device associated with the beverage system or sending a command to the beverage system.

16. The non-transitory computer-readable device of claim 15, wherein the sensor data includes: (i) foot traffic data surrounding the beverage system, (ii) eye tracking data indicating a consumable product and a duration a user looked at the consumable product, and (iii) a geolocation of the beverage system.

17. The non-transitory computer-readable device of claim 16, wherein the prediction comprises a recommended planogram for the beverage system, the recommended planogram based off of the sensor data, an amount the consumable product is purchased at the beverage system, and data of a customer that purchased the consumable product at the beverage system.

18. The non-transitory computer-readable device of claim 17, the operations further comprising moving the consumable product within the beverage system to match the recommended planogram.

19. The non-transitory computer-readable device of claim 15, wherein the prediction comprises: (1) an alert that a quantity of the consumable product is below a predefined threshold, and (2) a restocking order, the restocking order comprising: (i) a location of the beverage system; (ii) the consumable product to restock; (iii) a restock quantity; and (iv) a recommended restock time.

20. The non-transitory computer-readable device of claim 19, wherein the recommended restock time is based off (i) a time the consumable product is purchased, (ii) a geolocation of the beverage system, and (iii) traffic near the beverage system.
